(19) United States
(12) Patent Application Publication
(10) Pub. No.: US 2012/0310731 A1
(43) Pub. Date: Dec. 6, 2012

(54) METHOD AND SYSTEM FOR DISPLAYING RELATED PRODUCT INFORMATION

(75) Inventors: Jing Li, Hangzhou (CN); Yitao Gong, Hangzhou (CN); Gregory McNutt, Sunnyvale, CA (US); Jun Ye, Hangzhou (CN)

(73) Assignee: ALIBABA GROUP HOLDING LIMITED, George Town (KY)

(21) Appl. No.: 13/485,147

(22) Filed: May 31, 2012

(30) Foreign Application Priority Data
Jun. 2, 2011 (CN) 201110147530.5

(51) Int. Cl. G06Q 30/02

(52) U.S. Cl. 705/14.45; 705/14.72; 705/14.69

(57) ABSTRACT

Displaying related product information includes receiving a request to display main product information of a requested main product, retrieving related product information for a plurality of related products of the requested main product from a product relationship center, selecting a predetermined number of related products based at least in part on association strengths between the requested main product and a plurality of related products of the requested main product, and displaying product information of the selected related products.

### CROSS REFERENCE TO OTHER APPLICATIONS

This application claims priority to People's Republic of China Patent Application No. 201110147530.5 entitled A METHOD AND SYSTEM OF DISPLAYING RELATED PRODUCT INFORMATION filed Jun. 2, 2011 which is incorporated herein by reference for all purposes.

### FIELD OF THE INVENTION

This application involves the field of network data processing; in particular, it involves a method and system of displaying related product information.

### BACKGROUND OF THE INVENTION

E-commerce is a process that involves interaction with product information over the Internet. E-commerce is established on a foundation of computer networks, and is realized via electronics and electronic technology means. The implementation platform for e-commerce is the online trading platform. Products displayed on online trading platforms are referred to as online products. There can be numerous similar products for any given online product. Comparable products in the same category can be made by different manufacturers and be marketed under different brand names. Nevertheless, such products can be similar in appearances, material, functions, and user experience.

In some systems, when a product is currently being displayed on a webpage, its product information is the primary content of the display interface and is referred to as the main product information. In addition to the main product information, there is an area that can be used to display related product information. By displaying related product information, users browsing the main product information are encouraged to click over to the webpages that display the related products and purchase the related products.

FIG. 1 is a system diagram depicting an example of a related product information display system. In this display system, a buyer-user 110 first submits a display request for main product information to the related product information display system 100. The buyer-user transaction data retrieval element 102 retrieves the buyer-user's historical transaction record. Using the buyer-user's historical transaction record, the fixed-interval transaction activity computation element 104 mines the related product information for the main product based on association rules and other algorithms, and computes the association strengths between the main product and related products. The related product selection element 106 then selects suitable related product information based on the computed association strengths. Finally, the related product information display element 108 displays the selected related product information on the main product information display page.

Example system 100 computes the association strengths between a main product and its related products based on historical transaction records each time in order to display related product information to the user. Because association strengths are mined for every display request, this lowers the efficiency of the example display system. Furthermore, when the display of related product information is a protracted process, there tends to be repetitive transmission of and responses to requests between the buyer-user and the display system, which not only wastes network transmission resources but further deteriorates the performance of the example display system.

### BRIEF DESCRIPTION OF THE DRAWINGS

Various embodiments of the invention are disclosed in the following detailed description and the accompanying drawings.

FIG. 1 is a system diagram depicting an example of a related product information display system 100.

FIG. 2 is a system diagram depicting an embodiment of a related product information display system.

FIG. 3 is a flow diagram depicting an embodiment of a process for displaying related product information.

FIG. 4 is a flow diagram depicting an embodiment of the process for determining association strength between a main product and a related product.

FIG. 5A is a flow diagram depicting an embodiment of the process for determining association strengths between a main product and a related product.

FIG. 5B is a diagram of an example illustrating a first jump between two product information webpages.

FIG. 5C is a diagram of an example illustrating a second jump between two product information webpages.

FIG. 5D is a diagram of an example illustrating a third jump between two product information webpages.

FIG. 6 is a flow diagram depicting an embodiment of the process for displaying related product information.

FIG. 7 is a block diagram depicting an embodiment of the product incidence graph.

FIG. 8 is a flowchart depicting an embodiment of the process for displaying related product information.

FIG. 9 is a block diagram depicting an embodiment of the system for displaying related product information.

FIG. 10 is a block diagram depicting an embodiment of the association strength retrieval module.

FIG. 11 is a block diagram depicting an embodiment of the system for displaying related product information.

FIG. 12 is a block diagram depicting an embodiment of the system for displaying related product information.

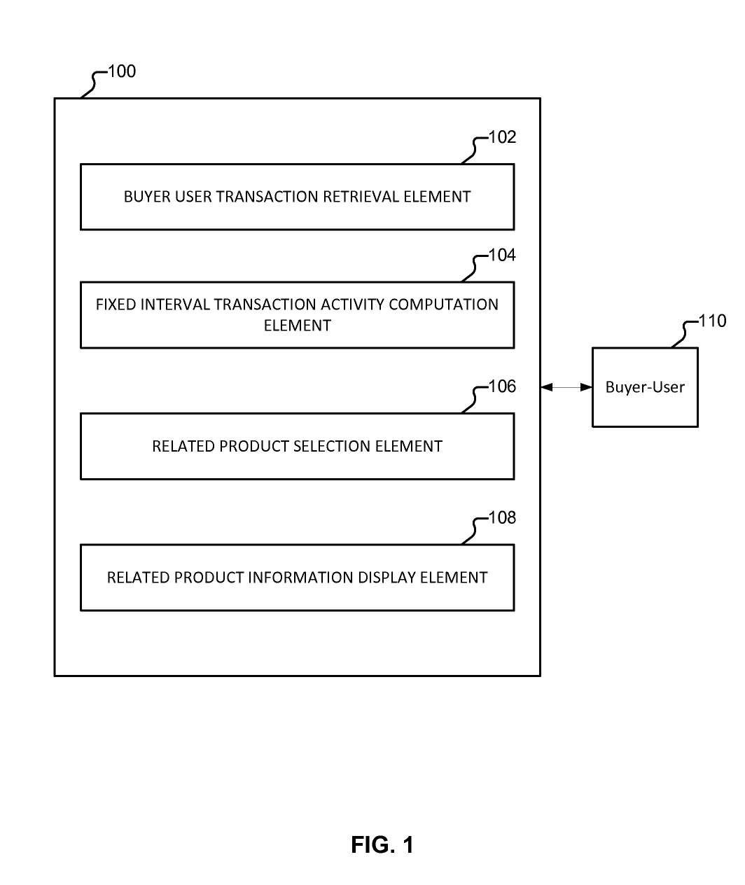

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method and system for displaying related product information is disclosed. One embodiment relates to a product relationship center. The product relationship center stores, in advance, associations between main products and related products.

In accordance with an aspect of the present embodiments, displaying related product information includes receiving a request from a buyer-user to display main product information. Related product information is selected for display with the requested main product information based on the association strengths between the main product and related products. In some embodiments, the association strength between a main product and a related product is based on the main product seller-user's responses to association requests. In some embodiments, the association strength between a main product and a related product is based on the historical transaction records involving the main product and the related product. In some embodiments, the association strength between a main product and a related product is based on the main product seller-user's responses to association request and the historical transaction record. In some embodiments, main product information, related product information, and association strengths are stored in a product incidence graph in the product relationship center.

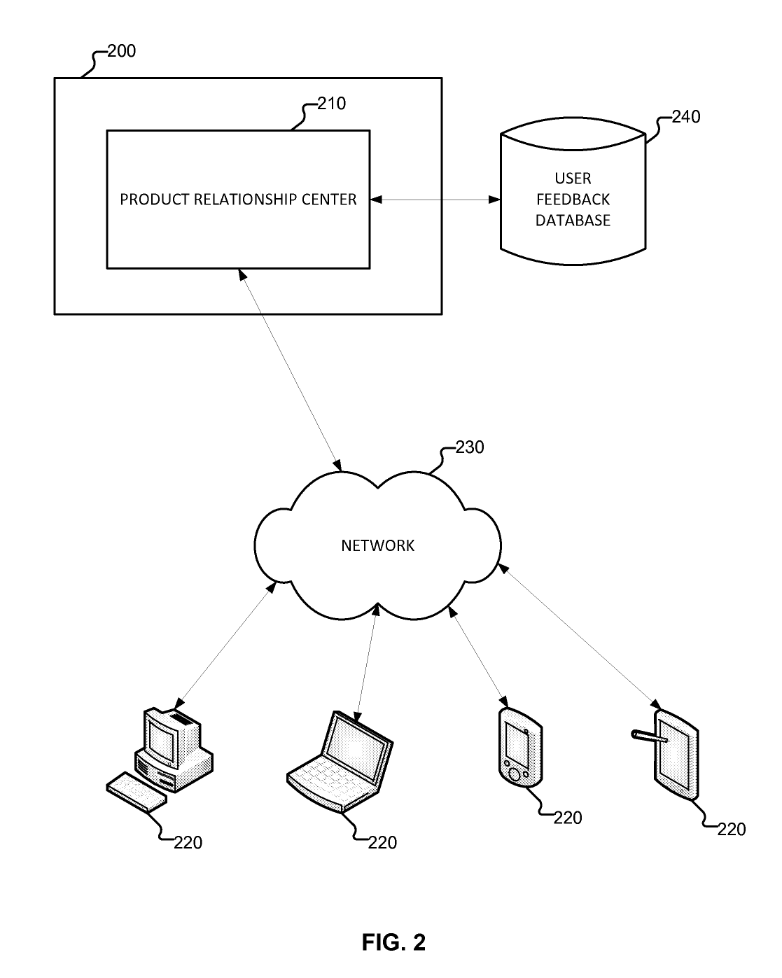

FIG. 2 is a system diagram depicting an embodiment of a related product information display system 200. System 200 may be implemented using one or more computing devices such as a personal computer, a server computer, a handheld or portable device, a flat panel device, a multi-processor system, a microprocessor based system, a set-top box, a programmable consumer electronic device, a network PC, a minicomputer, a large-scale computer, a special purpose device, a distributed computing environment including any of the foregoing systems or devices, or other hardware/software/firmware combination that includes one or more processors, and memory coupled to the processors and configured to provide the processors with instructions.

In the example shown, related product information display system 200 includes a product relationship center 210, which in some embodiments includes one or more devices having one or more processors coupled to one or more memories. Product relationship center 210 includes one or more interfaces configured to receive user inputs, such as user inputs sent by client devices 220 over a network 230, which may be the Internet or another communications network. Examples of a communication interface include, without limitations, external connections such as a port, cable, wired or wireless network interface card, etc., and internal connections such as a communication bus. In some embodiments, the client device is a computing device such as a computer or mobile device with networking capabilities. Product relationship center 210 has access to a user feedback database 240 that stores product information.

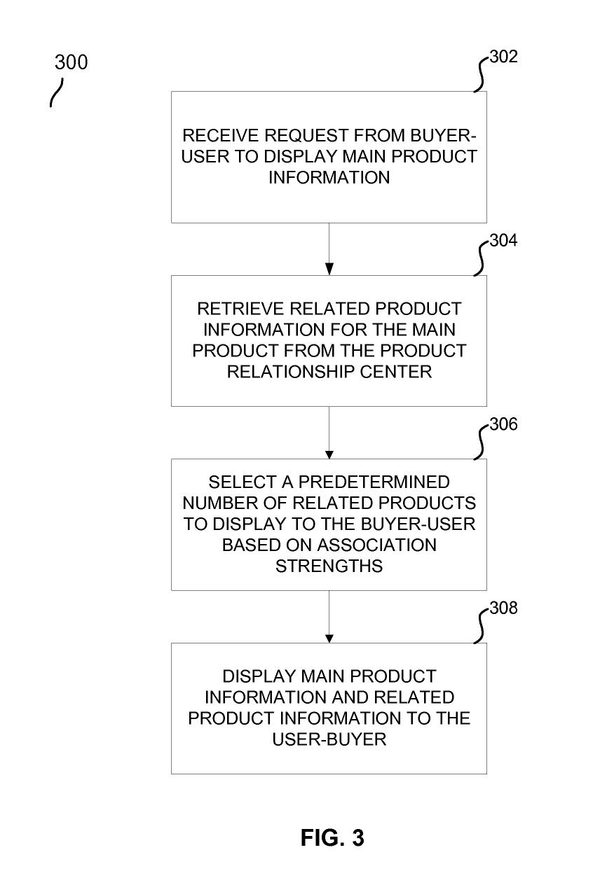

FIG. 3 is a flow diagram depicting an embodiment of a process 300 for displaying related product information. Process 300 may be performed on a system such as 200.

At 302, a request from a buyer-user to display main product information is received. In some embodiments, the buyer-user submits a request to display main product information by searching for the main product (e.g., “iPod™ headphones”). A main product is the product that the buyer-user had specifically searched for. Main product information refers to the information concerning the main product that is displayed as the primary content of a webpage. In addition to an area for displaying the main product information, the webpage also has an area for displaying information on certain related products (e.g., covers and chargers for iPod™). Due to brand recognition, buyer-users are generally more aware of brand name products and tend to search for brand name products first. Consequently, brand name products are more likely to become main products. Providing related product information yields a broader product selection for the buyer-user's search. The related product information that is displayed on the webpage permits the buyer-user who has searched for a main product and is viewing the webpage for the main product to click over to other webpages that display related products that may likely interest the buyer-user. Given the likelihood that the buyer-user will purchase the related products, related product information provides additional or alternate sales opportunities.

At 304, related product information for the main product is retrieved from the product relationship center. The product relationship center stores product information and the relationship between main products and related products. In some embodiments, the relationships between main products and related products are expressed as association strengths that range from 0 to 1. The closer the value of the association strength is to 1, the greater the likelihood that a buyer-user who is interested in the main product would purchase the related product. An association strength value of 1 indicates that there is only one related product for the main product. On the other hand, when a main product and a related product have an association strength value of 0, the two products are considered unrelated. Under normal circumstances, association strengths have values that range between 0 and 1.

In some embodiments, the association strength between a main product and a related product is based on the main product seller-user's responses to association requests. In some embodiments, the association strength between a main product and a related product is based on the historical transaction records involving the main product and the related product. In some embodiments, the association strength between a main product and a related product is based on the main product seller-user's responses to the association request and the historical transaction record.

At 306, based on the magnitude of the association strengths, a predetermined number of related products are selected for display. In some embodiments, only a predetermined number of related products with the highest association strengths are selected for display. For example, suppose that main product X has ten related products but the predetermined number of related products that are to be displayed with a main product is four. In this case, the four related products with the highest association strengths to main product X are selected for display.

At 308, product information for the selected related products is displayed to the user on the main product webpage. The related product information for the related products that were selected at 306 is displayed with the main product information. In some embodiments, the area for displaying the related product information has a flexible format. In some embodiments, the related product information is displayed pursuant to a flexible ranking method. For example, suppose that the association strength between a first related product A and a main product X is 0.9 and the association strength between a second related product B and the main product X is 0.5. Related product A can be ranked ahead of related product B on the display page for main product X.

In some embodiments, the product relationship center stores product information, and the relationships between main products and related products. Upon receiving a request from a buyer-user to display main product information, the related product information for the main product and the association strength can be directly retrieved from the product relationship center. Related product information that is to be displayed with the main product information may be selected based on association strengths. Because it is unnecessary to re-compute association strengths, display efficiency is substantially increased. Moreover, expediting the display process avoids repetitive requests and responses between the buyer-user and the display system and thereby conserves network transmission resources and improves the performance of the display system.

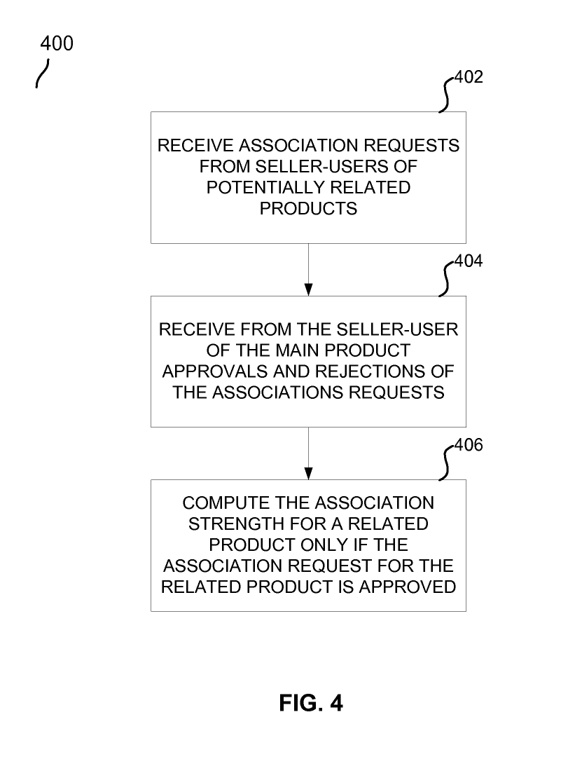

FIG. 4 is a flow diagram depicting an embodiment of the process 400 for determining association strength between a main product and a related product. In some embodiments, the association strength between a main product and a related product is based on the main product seller-user's responses to association requests from other seller-users.

At 402, after a seller-user posts a main product, association requests from other seller-users selling potentially related products and providing product information for the potentially related products are received. The association requests from other seller-users identify potentially related products and propose establishing a relationship between the main product and the potentially related products. An association request includes request parameters that indicate the amount of commission (e.g., virtual points, actual money) that the seller-user of the potentially related products will submit to the seller-user of the main product if a buyer-user accesses the potentially related product as a related product of the main product and takes an action with respect to the potentially related product (e.g., purchasing the related product, viewing product information of the related product).

At 404, an association request is handled by the seller-user of the main product. In some embodiments, a seller-user who owns a main product is able to approve or reject association requests from seller-users of potentially related products via a user interface. In doing so, a seller-user who owns a main product has the ability to independently control which products from other seller-users are displayed as related products to the buyer-sellers viewing the webpage for the main product. In some embodiments, the association strength between a main product and a potentially related product is determined only if the seller-user of the main product approves the association request for the potentially related product.

In some embodiments, a seller-user who owns a main product is able to independently select the related products that are displayed with the main product based at least in part on the amount of commission offered by the seller-users of potentially related products. In various embodiments, the amount of commission can be denominated in points or cash value. In some embodiments, the amount of commission can be defined as a percentage of the price of the related product or as a fixed amount.

At 406, if a main product seller-user approves an association request for a related product, the association strength between the main product and the related product is determined. In some embodiments, the association strength between the main product and the related product is determined according to Formula (I):

$${T}_{i} = \frac{{d}_{i}}{{d}_{1} + … + {d}_{n}} \qquad ( 1 )$$

Where Tᵢ denotes the association strength for a product i owned by seller-user i, wherein dᵢ denotes the value of the request parameters of the seller-user i, and wherein the plurality of seller-users includes a total of n seller-users.

For example, suppose Alice and Bob are both seller-users. First, Alice submits an association request for her product A to be related to a main product M (which is sold by seller-user Charlie). Alice's association request has a request parameter of $1 (or 1%). Charlie approves Alice's association request for product A. Because A is thus far the only related product to M, the value of the association strength between the main product M and Alice's related product A is 1. Subsequently, Bob sees main product M and believes that there is also an association between his product B and the main product M. Bob wants to establish a stronger association between B and M, so he submits an association request to the main product seller-user with a request parameter of $2 (or 2%). The seller-user of main product Mapproves Bob's request as well, whereupon Bob's related product B will be ranked before Alice's related product A on the display page for the main product M. This is because B has a greater association strength value than A based on Bob's request parameter. In this situation, the value of the association strength between A and M is 1/(1+2), or 0.33 while the association strength between B and M is 2/(1+2), or 0.66.

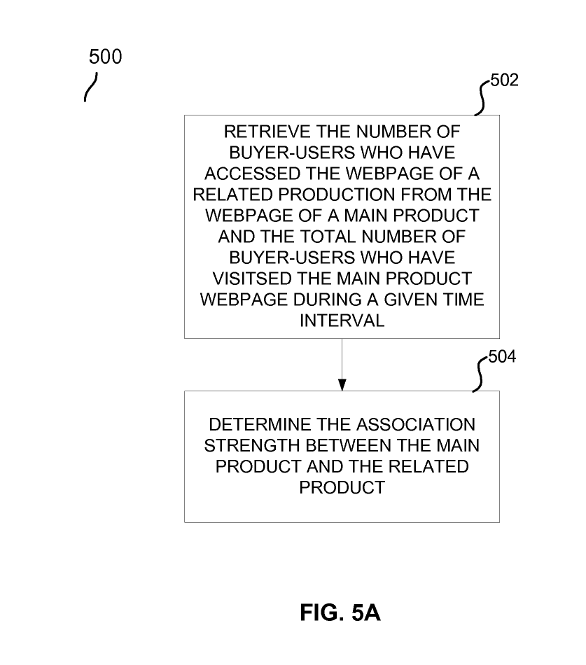

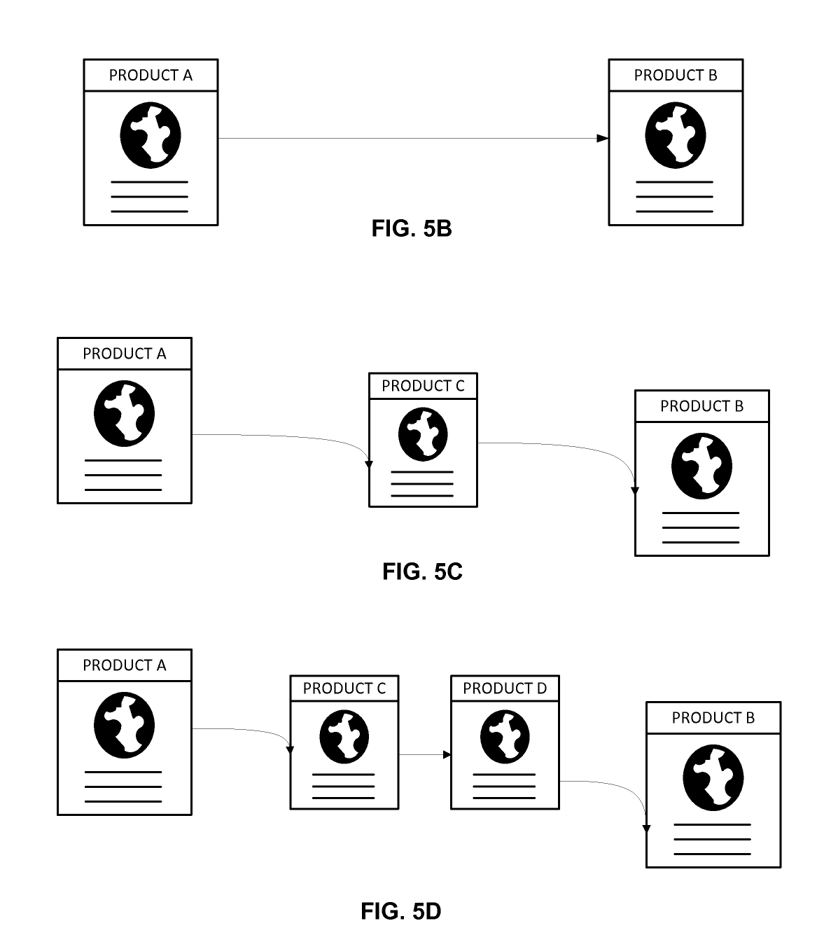

FIG. 5A is a flow diagram depicting an embodiment of the process 500 for determining association strengths between a main product and a related product. In some embodiments, the association strength between a main product and a related product can be determined based on historical transaction records. In some embodiments, if no other seller-users submit an association request for a product, then the association strength between a main product and related products can be determined based on historical transaction records. In some embodiments, in order to conserve computational resources, this determination may be only performed on a limited and periodic basis.

At 502, for a given time interval, the number of buyer-users who have accessed the webpage of a related product directly from the webpage of a main product and the overall number of buyer-users who have visited the main product webpage are retrieved.

The relationships between the main product and other related products are obtained from historical transaction records. If a buyer-user who views main product A subsequently purchases related product B, then a relationship is established between A and B. The association strength between A and B is determined using a set of predetermined association rules based on the number of “jumps.” A “jump” occurs when a buyer-user accesses one product information webpage from another product information webpage (e.g., a product information webpage for product A displays a link to a webpage for a related product B, and a buyer-user who started to browse product A accesses the webpage for product B via the link displayed on product A's webpage). When a buyer-user makes a single jump between two webpages, the buyer-user had directly accessed the second product information webpage from the first product information webpage. If a buyer-user accessed a second product information webpage from a first product information webpage via a third product information webpage, then there is said to be two jumps between the first and second webpages.

FIG. 5B is a diagram of an example illustrating a first jump between two product information webpages A and B. In the example in FIG. 5B, a first jump constitutes a buyer-user accessing product webpage B directly from product webpage A.

FIG. 5C is a diagram of an example illustrating a second jump between two product information webpages A and B. In this example, the buyer-user makes two jumps by first accessing product webpage A then product webpage C before finally accessing product webpage B.

FIG. 5D is a diagram of an example illustrating a third jump between two product information webpages A and B. In the example shown in FIG. 5D, the buyer-user makes three jumps from product webpage A to product webpage B by accessing product webpage A then product webpages C and D before accessing product webpage B.

Referring to FIG. 5A, at 504, the association strengths between the main product and related products are determined. In some embodiment, the association strength between a main product A and a related product B is determined based on the number of buyer-users who purchased related product B after directly and indirectly accessing product page B from product page A during a given time interval relative to the total number of buyer-users who have viewed product page A during the same period. For example, given a particular time interval where a total number of Y buyer-users have viewed product page A, suppose that after viewing product page A, the number of buyer-users who accessed product page B in the first jump is X1, and the number of buyer-users who accessed product page B in the second jump is X2, and in the third jump is X3. The association strength between B and A is: (X1+X2*BounceEliminationRate1+X3*BounceEliminationRate2)/Y. In some embodiments, the bounce elimination rate for a particular jump is an empirical value that represents the percentage of users who leave a certain webpage immediately after entering it without taking further action with respect to the product displayed on the page. For example, if X1=30, X2=20, X3=10, Y=100, and the bounce elimination rates are 50% and 40% then the relationship strength between B and A is 0.44.

The association strength between a main product and a related product can vary. In some embodiments, the association strength between a main product and a related product can be increased through data mining of buyer-users' historical transaction records. In some embodiments, the seller-user of a related product can increase the association strength to a main product by increasing the value of the seller-user's request parameters, such as by paying a higher commission or fee to the seller-user of the main product.

In some embodiments, the association strength between a main product and a related product is determined based on both the main product seller-user's responses to association requests and the historical transaction records for the related product. The association strength for a main product and a related product includes both the association strength derived from historical transaction records and the association strength derived from association requests. For example, the association strength for a main product A and related product B obtained from the historical transaction records is 0.5, i.e., 50% of buyer-users who purchased main product A also purchased related product B. In addition, the seller-user of B also sends an association request to the seller-user of A, and the association strength computed based on the association request sent by the seller-user of B is: Tᵢ=1/(1+2+3+4)=0.1. Therefore, the association strength between product A and product B is 0.5+0.1=0.6.

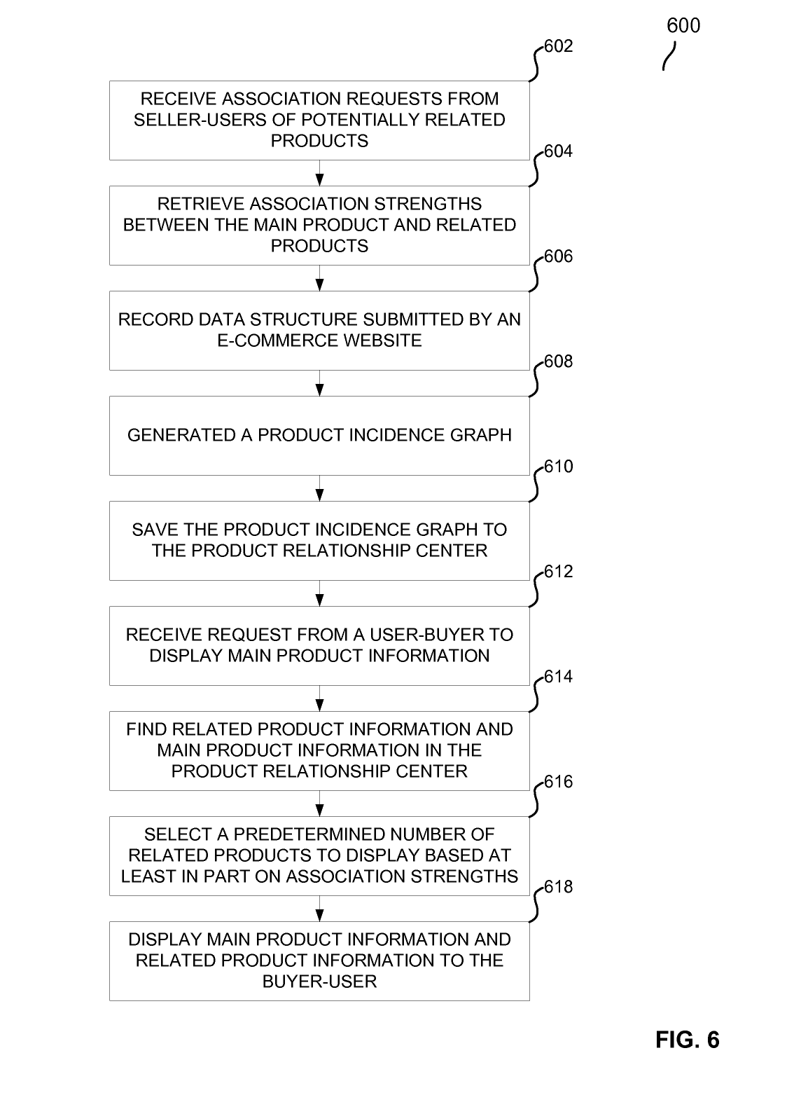

FIG. 6 is a flow diagram depicting an embodiment of a process for displaying related product information.

At 602, after a seller-user posts a main product, association requests from seller-users of potentially related products and potentially related product information are received. The association requests from other seller-users identify potentially related products and propose establishing a relationship between the main product and the potentially related products. The association request includes request parameters that indicate the amount of commission that the seller-user of the potentially related products will submit to the seller-user of the main product if a buyer-user accesses the potentially related product as a related product of the main product and takes an action with respect to the potentially related product.

At 604, the association strengths of the main product and various related products are retrieved. In some embodiments, the association strength between a main product and a related product is based on the main product seller-user's responses to association requests. In some embodiments, the association strength between a main product and a related product is based on the historical transaction records involving the main product and the related product. In some embodiments, the association strength between a main product and a related product is based on the main product seller-user's responses to association requests and historical transaction records.

At 606, data submitted by an e-commerce website is recorded. In some embodiments, the data from the e-commerce website includes main product identifiers, related product identifiers, and association strengths. In some embodiments, the data from the e-commerce website is included in a data structure with the following fields:

thirdparty_siteid, Main_product_id->[Related_product_id_list];

Where thirdparty_siteid is the website identifier, Main_product_id is the main product identifier, and Related_product_id_list is the list of related products that includes related product identifiers and association strengths of the related products to the main product.

At 608, a product incidence graph is generated based on the main product identifiers, related product identifiers, and association strengths. In some embodiments, the nodes of the product incidence graph represent main products and related products while the lines that connect pairs of nodes express association strengths. In some embodiments, the product incidence graph is periodically updated. In some embodiments, the periodic update of the product incidence graph includes adding, for a particular record in the data structure submitted by the e-commerce website, a node for the main product and a node for the related product. In addition, if an association exists between a main product and a related product, the corresponding product nodes are connected and the magnitude of the association strength is also added.

In some embodiments, the number of nodes may have an adjustable limit indicating that a maximum number of related products may exist for each main product. The maximum number of nodes permitted may depend on the size of the space available to display related product information on the main product webpage.

At 610, the product incidence graph is saved to the product relationship center. Once the product incidence graph has been generated and saved to the product relationship center, related product information and association strengths can be quickly retrieved by accessing the product incidence graph.

In some embodiments, a blank product incidence graph is first stored in the product relationship center and is subsequently populated with continuous updates using information from the data structure submitted by the e-commerce website. For example, a seller-user of non-OEM iPod earphones wants his products to appear at the bottom of the display webpage for the main product “Apple iPod™.” The seller-user of the non-OEM iPod earphones submits an association request. If the seller-user of the “Apple iPod” approves the association request, then the strength of the association between the non-OEM iPod earphones and the “Apple iPod” is determined and stored in the product relationship center.

At 612, a request from a buyer-user to display main product information is received. For example, the request can include a user query string indicating a main product of interest.

At 614, product information for all of the related products to the main product is found in the product relationship center.

At 616, based at least in part on the association strengths between the main product and the various related products, a predetermined number of related products are selected for display to the buyer-user.

At 618, product information for the related products selected at 616 is displayed to the buy-user along with the main product information.

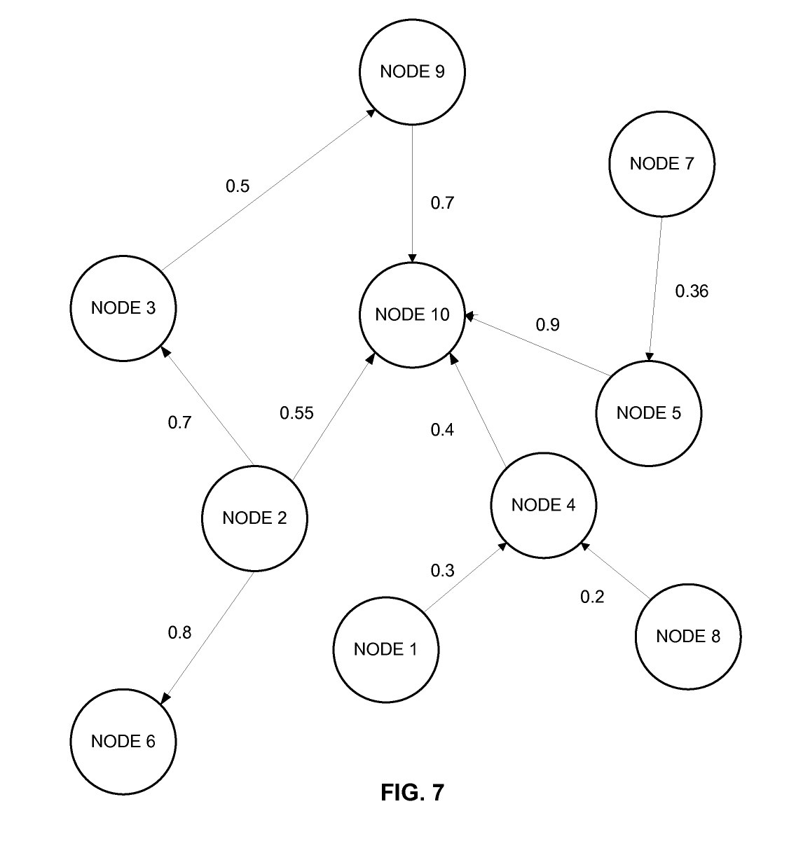

FIG. 7 is a block diagram depicting an embodiment of a product incidence graph. The nodes represent products. Nodes with arrows pointing to them are main product nodes while nodes with arrows pointing away from them are related product nodes. For example, Node 10 represents the 10^{th} record in a database of the product relationship center. Node 10 is a main product and is associated with four related products represented by Nodes 2, 4, 5, and 9. Node 2 represents the 2^{nd} product in the database. It is a related product of three main products represented by Nodes 3, 6, and 10. A node can be both a main product and a related product. For example, Node 3 represents a main product with respect to a related product represented by Node 2, and also Node 3 represents a related product of Node 9. In FIG. 7, The numerical value on the line connecting two nodes represents the value of the association strength between the main product at one node and the related product at the other node. For example, the associated strengths between the product of Node 10 and the products of Nodes 2, 4, 5, and 10 are 0.55, 0.4, 0.9, and 0.7, respectively.

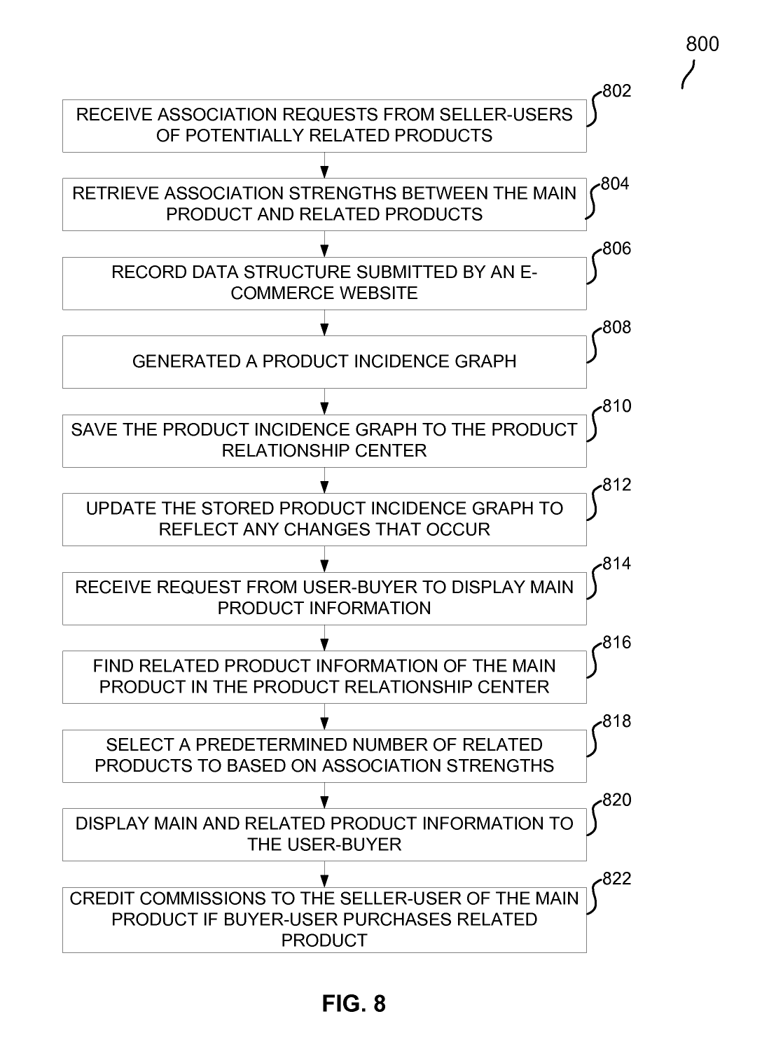

FIG. 8 is a flowchart depicting an embodiment of the process 800 for displaying related product information.

At 802, after a seller-user posts a main product, association requests from seller-users of potentially related products and potentially related product information are received. The association requests from other seller-users identify potentially related products and propose establishing a relationship between the main product and the potentially related products. The association request includes request parameters that indicate the amount of commission that the seller-user of the potentially related products will submit to the seller-user of the main product if a buyer-user accesses the potentially related product as a related product of the main product and takes an action with respect to the potentially related product.

At 804, the association strengths of the main product and various related products are retrieved. In some embodiments, the association strength between a main product and a related product is based on the main product seller-user's responses to association requests. In some embodiments, the association strength between a main product and a related product is based on the historical transaction records involving the main product and the related product. In some embodiments, the association strength between a main product and a related product is based on the main product seller-user's responses to association requests and the historical transaction records.

At 806, data submitted by an e-commerce website is recorded. In some embodiments, the data from the e-commerce website includes main product identifiers, related product identifiers, and association strengths.

At 808, a product incidence graph is generated based on the main product identifiers, related product identifiers, and association strengths. In some embodiments, the nodes of the product incidence graph represent main products and related products while the lines that connect pairs of nodes express association strengths.

At 810, the product incidence graph is stored in the product relationship center. In some embodiments, the product incidence graph stored in the product relationship center has the particular data storage structure of the table shown below.

| Pk_id | thirdparty_siteid | Main_product_id | S_main_id | Related_product_id_list |
|---|---|---|---|---|
| 1 | www.aliexpress.com | 1001 | 2001 | {5, 2001, 0.9; |
| | | | | 6, 2005, 0.8; |
| | | | | 7, 1688, 0.3} |
| 2 | www.amazon.com | 20001 | 300 | {10, 301, 0.8; |
| | | | | 11, 3002, 0.5} |

For the primary data results of the product relationship center saved in this table, internal memory level caches may be used to store designated information such as the Related_product_id_list and S_main_id corresponding to (thirdparty_site_id, Main_product_id). In some embodiments, the field thirdparty_siteid indicates third party websites that are identified by actual domain names. In some embodiments, numeric codes are used to identify third party websites. The field Related_product_id_list contains association strengths. In some embodiments, data is stored in the following format: {related product pk_id1, related product seller-user id1, association strength 1; related product pk_id2, related product seller-user id2, association strength 2; . . . }. To conserve storage resources, in some embodiments, related products with association strengths below a certain threshold may be disregarded; in some embodiments, the length of this list is limited to a set number of related products. In some embodiments, in order to enhance performance, the table representing the product incidence graph may be stored in an internal-memory cache.

At 812, association strengths stored in the product relationship center are updated in real time to reflect any changes that occur. As seller-users submit association requests, it is possible for association strengths to change at any time, even as between the same pairs of main products and related products. For example, association strength can change when a seller-user of a particular related product terminates an existing association with a main product. The association strength between a main product and a related product can also change as a result of buyer-users' transaction activities. In some embodiments, when changes occur in the association strengths between the main product and related products, the association strengths saved in the product relationship center are updated in real time. In some embodiments, the association strengths stored in the product relationship center are updated via real time updates to the lines connecting the nodes in the product incidence graph and the values that correspond to the connecting lines.

At 814, a request to display main product information is received.

At 816, all related product information for the main product requested at 814 are found in the product relationship center.

At 818, a predetermined number of related products are selected for display based on association strengths.

At 820, product information for the selected related products are displayed to the user on the main product webpage.

At 822, when a buyer-user takes an action with respect to a related product, commissions are credited to the account of the main product seller-user in amounts based on the request parameter of the association request submitted at 802 by the seller-user of the related product. In some embodiments, related product information is displayed on the main product display page. If a buyer-user accesses the webpage for the related product from main product webpage and takes an action with respect to the related product, then commissions are credited to the registered account of the main product seller user. In some embodiments, the amount of commissions credited to the main product seller user corresponds to the request parameters of the association request submitted by the seller-user of the related product at 802. In some embodiments, the buyer-user takes an action that includes accessing the product webpage of the potentially related product and/or purchasing the potentially related product. For example, related product B is associated with main product A. The seller-user of related product B submits an association request to the seller-user of main product A and offers a commission of $2 per transaction to the seller-user of main product A if the purchaser of product B came by way of A's product webpage. If the seller-user of main product A approves the request, then the amount of the commission that he or she is entitled to can be computed and credited to his or her registered account periodically (e.g., at the end of each month). In some embodiments, the amount of commission that the seller-user of main product A is entitled to collect from the seller-user of related product B is based on the number of users who accessed related product B via main product A to related product B and purchased related product B during the month.

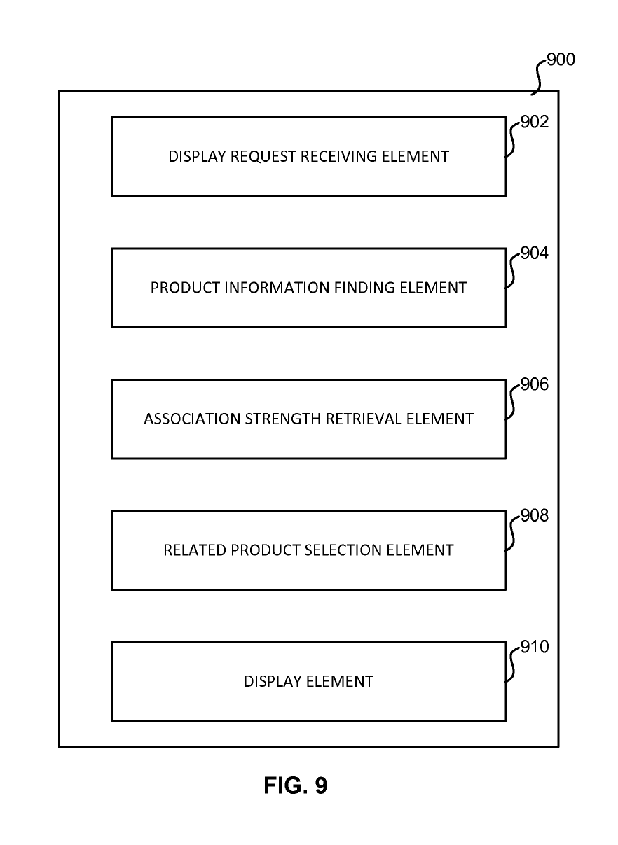

FIG. 9 is a block diagram depicting an embodiment of the system 900 for displaying related product information. As shown in FIG. 9, the related information display system includes: a display request receiving element 902, for receiving requests from a buyer-user to display main product information; a product information finding element 904, for finding related product information of the main product in the product relationship center; an association strength retrieval element 906, for retrieving the association strengths between main products and related products; a related product selection element 908, for selecting a predetermined number of related products based on association strengths; and a display element 910, for displaying main product information and related product information to the buyer-user.

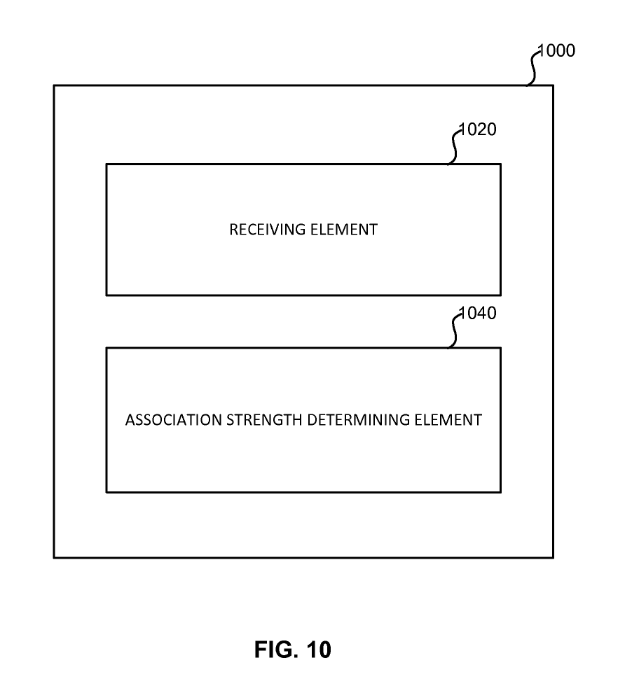

FIG. 10 is a block diagram depicting an embodiment of the association strength retrieval module 1000. Association strength retrieval module 1000 can be used to implement element 950 in FIG. 9. In some embodiments, the relationships between main products and related products are expressed as association strengths between the main product and related products. The association strength retrieval module depicted in FIG. 10 retrieves the association strengths between main products and related products. As shown in FIG. 10, the retrieval module 1000 includes a receiving element 1020, for receiving association requests from other seller-users after a seller-user posts a main product. The association requests from other seller-users identify potentially related products and propose establishing a relationship between the main product and the potentially related products. An association request includes request parameters that indicate the amount of commission that the seller-user of the potentially related products will submit to the seller-user of the main product if a buyer-user accesses the potentially related product as a related product of the main product and takes an action with respect to the potentially related product.

As shown in FIG. 10, the retrieval module also includes an association strength determination element 1040, for determining the association strengths between a main product and a related product. In some embodiments, the association strengths between a main product and related products are based on at least one of: the main product seller-user's responses to association requests and historical transaction records.

When association strength is based on the main product seller-user's response to association requests, association strength retrieval element 1040 may be configured to compute the association strengths of related products according to Formula (I):

$${T}_{i} = \frac{{d}_{i}}{{d}_{1} + … + {d}_{n}} \qquad ( 1 )$$

Where Tᵢ denotes the association strength for a product i owned by seller-user i, wherein dᵢ denotes the value of the request parameters of the seller-user i, and wherein the plurality of seller-users includes a total of n seller-users.

When the association strength between a main product and related products is based on historical transaction records, the association strength retrieval element 1040 may be configured to determine, for a given time interval, the number of buyer-users who took an action after accessing the related product information page from the main product information page and the number of users who have accessed the main product information page. The association strength retrieval element 1040 may be further configured to compute the association strength based on the ratio of the number of buyers who took an action with respect to the related product and the number of buyers who accessed the main product information page.

In the embodiments of the present application, the product relationship center stores product information and the relationships between main products and related products. Upon receiving a request from a buyer-user to display main product information, association strengths can be directly retrieved from the product relationship center and related product information can be selected for display. Because it is unnecessary to re-compute association strengths, display efficiency is substantially increased. In addition, expediting the display of related product information prevents the repetitive transmission of requests and responses between the buyer-user and the display system, thereby conserving network transmission resources and improving the performance of the display system.

Furthermore, main product seller-users can approve and reject association requests from other seller-users and are thereby able to independently control the related products that are displayed on the main product display page. By combining the seller-user's responses to association requests and historical transaction records, the embodiments of the present application provides more flexible, accurate, and relevant related product information for display to buyer-users.

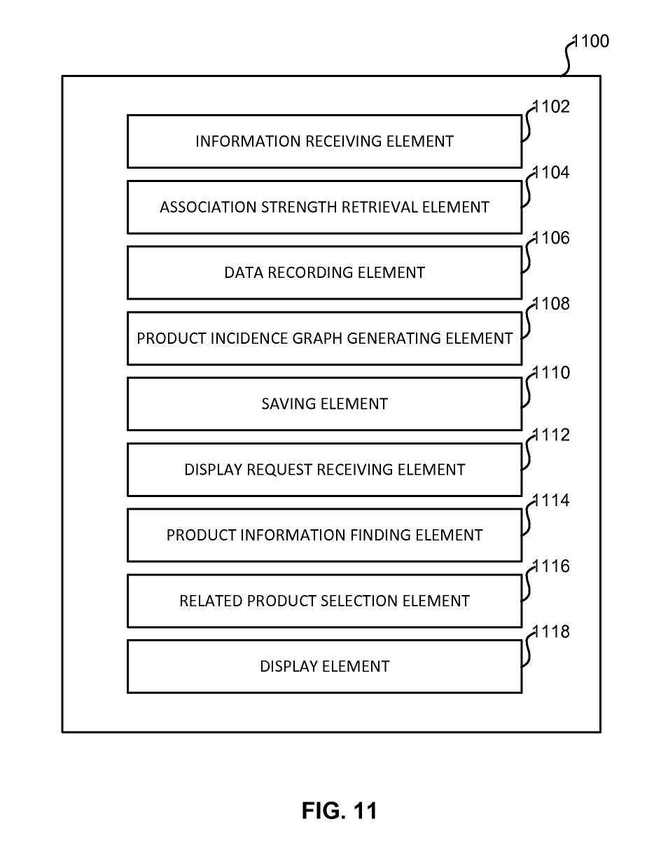

FIG. 11 is a block diagram depicting an embodiment of the system 1100 for displaying related product information. As shown in FIG. 11, system 1100 includes: an information receiving element 1102, for receiving association requests and product information submitted by seller-users of potentially related products; an association strength retrieval element 1104, for retrieving association strengths between main products and related products; a data recording element 1106, for recording data submitted by an e-commerce website; a product incidence graph generating element 1108, for generating product incidence graphs based on the data submitted by the e-commerce website; a saving element 1110, for saving the product incidence graph to the product relationship center; a display request receiving element 1112, for receiving requests from a buyer-user to display main product information; a product information finding element 1114, for finding the related product information of the main product in the product relationship center; a related product selection element 1116, for selecting a predetermined number of related products based on association strength; and a display element 1118, for displaying main product information and related product information to the buyer-user.

The product relationship center is a centralized online resource that maintains all online products. All of the individual components of the display system are able to interact with the product relationship center. As a result, associations between main products and related products can be shared efficiently among various system components as well as various display systems.

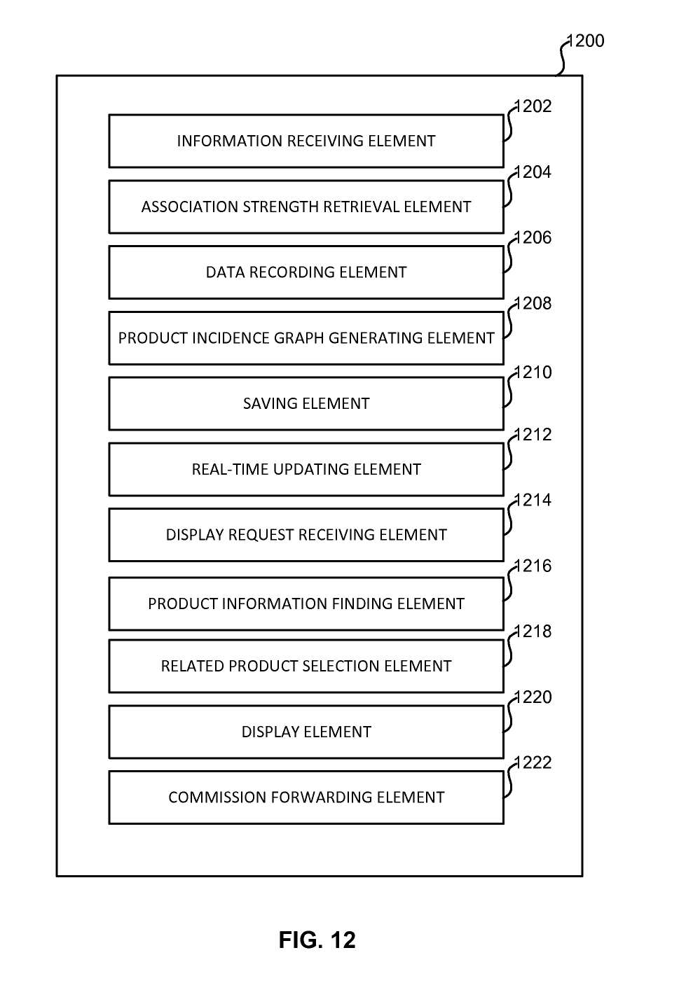

FIG. 12 is a block diagram depicting an embodiment of the system 1200 for displaying related product information. As shown in FIG. 12, system 1200 includes: an information receiving element 1202, for receiving association requests and product information submitted by seller-users of potentially related products; an association strength retrieval element 1204, for retrieving association strengths between main products and related products; a data recording element 1206, for recording data submitted by the e-commerce website; a product incidence graph generating element 1208, for generating product incidence graphs based on the data submitted by the e-commerce website; a saving element 1210, for saving the product incidence graph to the product relationship center; a real-time updating element 1212, for performing real-time updates of the association strengths saved in the product relationship center; a display request receiving element 1214, for receiving requests from a buyer-user to display main product information; a product information finding element 1216, for finding the related product information of the main product in the product relationship center; a related product selection element 1218, for selecting a predetermined number of related products based on association strength; a display element 1220, for displaying main product information and related product information to the buyer-user; and a virtual point forwarding element 1222, for forwarding commissions to the registered account of the main product seller-user when a buyer-user takes an action with respect to the related product displayed to the buyer-user.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software product which can be stored in a nonvolatile storage medium (such as optical disk, flash storage device, mobile hard disk, etc.), including a number of instructions for making a computer device (such as personal computers, servers, network equipment, etc.) to implement the methods described in the embodiments of the present invention. The modules may be implemented on a single device or distributed across multiple devices. The functions of the modules may be merged into one another or further split into multiple sub-modules.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for displaying related product information, comprising:
receiving a request to display main product information of a requested main product, wherein the requested main product is listed for sale by a first seller-user;
retrieving related product information for a plurality of related products of the requested main product from a product relationship center, wherein:
the product relationship center stores product information for a plurality of products and a plurality of product relationships;
each product relationship indicates: an association between a main product and a related product, and an association strength;
the association strength is determined based at least in part on a response of a seller-user of the main product to an association request made by a seller-user of the related product;
selecting, using one or more processors, a predetermined number of related products is based at least in part on association strengths between the requested main product and a plurality of related products of the requested main product; and
displaying product information of the selected related products.

2. The method of claim 1, wherein association strengths between a main product and its related products are determined by:
receiving a plurality of association requests from a plurality of seller-users of a plurality of potentially related products for the main product, wherein an association request includes a request parameter that indicates a commission amount a second seller-user of a potentially related product will submit to the seller-user of the main product in the event a buyer-user takes an action with respect to the potentially related product;
receiving, from a seller-user of the main product, an approval or rejection for each of the association requests; and
determining the association strengths between the main product and its related products, wherein the seller-user of the main product has approved the association request for the related product.

3. The method of claim 2, wherein the association strength between the main product and a potentially related product is determined according to:
$${T}_{i} = \frac{{d}_{i}}{{d}_{1} + … + {d}_{n}}$$
wherein Tᵢ denotes the association strength for a product i owned by seller-user i, wherein dᵢ denotes the value of the request parameters of the seller-user i, and wherein the plurality of seller-users includes a total of n seller-users.

4. The method of claim 2, wherein the action taken with respect to the potentially related product includes: accessing a product information page of the potentially related product, completing a purchase transaction of the potentially related product, or both.

5. The method of claim 1, wherein product information of the selected related products are displayed in an order based at least in part on the association strengths between the main product and the selected related products.

6. The method of claim 2, wherein association strengths between a main product and its related products are determined based on historical transaction records.

7. The method of claim 6, wherein determining the association strengths based on historical is transaction records comprises:
determining a total number of buyer-users who accessed a product information page of the main product during a time interval;
determining a total number of buyer-users who linked to a product information page of a related product of the main product from the product information page of the main product during the time interval; and
determining a ratio of the total number of buyer-users who linked to the product information page of the related product from the product information page of the main product during the time interval, and the total number of buyer-users who accessed the product information page of the main product during the time interval.

8. The method of claim 7, wherein the total number of buyer-users who linked to the product information page of the related product from the product information page of the main product includes buyer-users who access the product information page of the related product from the product information page of the main product in a number of jumps, wherein a jump is accessing a second product information page second product directly from a first product information page of a first product.

9. The method of claim 7, wherein the total number of buyer-users who linked to the product information page of the related product from the product information page of the main product includes a bounce elimination rate wherein the bounce elimination rate is a measure of the number of buyer-users who access the product information page of the related product without taking an action with respect to the related product.

10. The method of claim 1, further comprising:
receiving, from an e-commerce website, data that includes product information for a plurality of products and a plurality of association strengths;
generating a product incidence graph based at least in part on the received data, wherein:
a node in the product incidence graph represents a main product or a related product; and
a line in the product incidence graph connects a main product node with a related product node and indicates an association strength between the main product and the related product; and
storing the product incidence graph in the product relationship center.

11. The method of claim 10, further comprising:
updating the product incidence graph stored in the product relationship center to correspond to a change in the data, wherein the change in the data includes: an addition or a deletion of product, and a change in an association strength between a main product and a related product.

12. The method of claim 1, further comprising:
forwarding a commission amount to a registered account of the seller user of the main product in the event that a buy-user takes an action with respect to a related product, wherein the commission amount is forwarded based at least in part on the request parameter of the association request submitted by the second seller-user.

13. A system for displaying related product information comprising one or more processors configured to:
receive a request to display main product information of a requested main product, wherein the requested main product is listed for sale by a first seller-user;
retrieve related product information for a plurality of related products of the requested main product from a product relationship center, wherein:
the product relationship center stores product information for a plurality of and a plurality of product relationships;
each product relationship indicates an association strength between a main product and a related product;
the association strength is determined based at least in part on responses of a seller-user of the main product to a plurality of association requests;
select, based at least in part on the association strength between the requested main product and a plurality of related products, a predetermined number of related products;
display product information of the selected related products; and
a memory coupled to the one or more processors and configured to provide the processor with instructions.

14. The system of claim 13, wherein the one or more processors are further configured to:
receive a plurality of association requests from a plurality of seller-users of a plurality of potentially related products for the main product, wherein an association request includes a request parameter that indicates a commission amount a second seller-user of a potentially related product will submit to the seller-user of the main product in the event a buyer-user takes an action with respect to the potentially related product;
receive, from a seller-user of the main product, an approval or rejection for each of the association requests; and
determine the association strengths between the main product and its related products, wherein the seller-user of the main product has approved the association request for the related product.

15. The system of claim 14, wherein the one or more processors are further configured to determine the association strength between the main product and a potentially related product according to the following formula:
$${T}_{i} = \frac{{d}_{i}}{{d}_{1} + … + {d}_{n}}$$
wherein Tᵢ denotes the association strength for a product i owned by seller-user i, wherein dᵢ denotes the value of the request parameters of the seller-user i, and wherein the plurality of seller-users includes a total of n seller-users.

16. The system of claim 14, wherein the action taken with respect to the potentially related product includes: accessing a product information page of the potentially related product, completing a purchase transaction of the potentially related product.

17. The method of claim 13, wherein product information of the selected related products are displayed in an order based at least in part on the association strengths between the main product and the selected related products.

18. The system of claim 14, wherein the one or more processor is further configured to determine the association strength based on historical transaction records.

19. The system of claim 18, wherein the one or more processors are further configured to:
determine a total number of buyer-users who accessed a product information page of the main product during a time interval;
determine a total number of buyer-users who linked to a product information page of a related product of the main product from the product information page of the main product during the time interval; and
determine a ratio of the total number of buyer-users who linked to the product information page of the related product from the product information page of the main product during the time interval, and the total number of buyer-users who accessed the product information page of the main product during the time interval.

20. The system of claim 19, wherein the total number of buyer-users who linked to the product information page of the related product from the product information page of the main product includes buyer-users who accesses the product information page of the related product from the product information page of the main product in a number of jumps, wherein a jump is accessing a second product information page directly from a first product information page.

21. The system of claim 19, wherein the total number of buyer-users who linked to the product information page of the related product from the product information page of the main product includes a bounce elimination rate wherein the bounce elimination rate is a measure of the number of buyer-users who access the product information page of the related product without taking an action with respect to the related product.

22. The system of claim 13, wherein the one or more processors are furthered configured to:
receive, from an e-commerce website, data that includes product information for a plurality of products and a plurality of association strengths;
generate a product incidence graph based at least in part on the received data, wherein:
a node in the product incidence graph represent one of a main product and a related product; and
a line in the product incidence graph connects a main product node with a related product node and indicates an association strength between the main product and the related product; and
store the product incidence graph to the product relationship center.

23. The system of claim 22, wherein the one or more processors are further configured to:
update the product incidence graph stored in the product relationship center to correspond to a change in the data, wherein the change in the data includes: an addition or a deletion of a product, and a change in an association strength between a main product and a related product.

24. The system of claim 13, wherein the one or more processors are further configured to:
forward a commission amount to a registered account of the seller user of the main product in the event that a buy-user takes an action with respect to the related product, wherein the commission amount is forwarded based at least in part on the request parameter of the association request submitted by the second seller-user.
